(19) United States
(12) Patent Application Publication
(10) Pub. No.: US 2018/0276938 A1
(43) Pub. Date: Sep. 27, 2018

(54) FOUR-PLAY KENO GAME

(71) Applicants: Ray Smith, Linden, NJ (US); Amanda Tears Smith, Linden, NJ (US)

(72) Inventors: Ray Smith, Linden, NJ (US); Amanda Tears Smith, Linden, NJ (US)

(21) Appl. No.: 15/469,537

(22) Filed: Mar. 26, 2017

(51) Int. Cl. G07F 17/32

(52) U.S. Cl. CPC G07F 17/329; G07F 17/3258; G07F 17/3288; G07F 17/3267

(57) ABSTRACT

A process of executing a keno-type wagering event wherein a processor recognizes. Provides two adjacent regions for display of two distinct distributional arrays. A first distributional array has 80 selectable alphanumerics in columns and rows, and a second distributional array has eight columns of 10 frames each forming four distinct pairs of linear arrays of frames for collecting ball drop outcomes. The processor recognizes degrees or numbers of correspondence along linear relationships between lines or columns in the first and second distributional arrays.

### BACKGROUND OF THE INVENTION

### 1. Field of the Invention

The present invention relates to the field of wagering games, particularly casino wagering games, and more particularly casino wagering games similar to well known wagering games such as Keno and variants of Keno.

### 2. Background of the Art

Keno is similar to Lotto. It was first introduced in China many years ago. The game was brought to the United States in the mid 1800's by Chinese immigrants who came to work in the mines and on the railroad. It is a very popular game and very easy to play. It is an exciting pastime and, most importantly, it offers the possibility of winning large payouts on relatively small wagers.

Keno is usually played in Casino lounges specifically allocated for the game, but there are so called ‘Keno runners’ who will collect tickets and deliver the winnings if the player wants to play from outside the lounge area. There are many television monitors spread all over the Casino halls to keep players informed of the winning numbers. There is also the video version of Keno. These are video slot-like coin, credit or ticket-in operated machines. It plays using the same principle with similar rules of the regular Keno, but the results occur much faster.

To play Keno, a player selects a minimum of 2 but no more than 10 numbers between 1 and 80. Each selection is called a ‘Spot’, so if 10 numbers are selected, a 10 Spot game is being played. Keno tickets are located at tables throughout the Casino and in the Casino's Keno lounge. The Casino provides a ‘Keno crayon’ for this purpose. A player simply marks a blank Keno ticket (or virtual electronic ticket on a gaming device) with the numbers of the selection. The ticket is presented to the Keno desk (or received by a processor that executes code to effect game play) with the wager and the clerk provides a duplicate ticket (or the processor indicates the selections on the vieo display). In a few minutes (or in less than a minute on electronic play), twenty numbered Keno balls will be drawn at random from a barrel containing 80 numbered balls (or 20 virtual balls or 20 random numbers are provided by a random number generator associated with and in communication with the processor), and if enough of the selected numbers are drawn, a winning event outcome occurs. The results are displayed on screens (or the video screen), called Keno boards, throughout the Casino.

Minimum bets can be as low as 5 cents, although some Casinos only accept bets of $1 or more. The house's Keno brochures gives information about payoffs and various tickets that can be played. The amount of money won is dependent upon the type of ticket played and the number of ‘spots’ caught. A player may wager on as many tickets as desired. One could win as much as $50,000 on a $1 wager in some Casinos.

The round of a Keno game is called a Keno race. In many Casinos, ‘multi-race’ Keno is featured, where one can play a number of consecutive Keno races at one time. The house advantage on Keno varies according to the Keno game played. It is always around 30% or more. The chance of hitting one number in 80 is 0.25.

Many variants and side bet or bonus games have been developed for play with Keno. Published U.S. Patent Application Document No. 20080070670 (Brunelle) describes a keno game including a set of playable symbols, from which a set of player symbols are selected. A set of winning symbols are selected from a set of potential winning symbols, with the set of potential winning symbols including the set of playable symbols and at least one wild symbol. The wild symbol may match any one of the player symbols, none of the player symbols, or a range of player symbols. The playable symbols are preferably numbers. Payouts preferably follow a pay table having a weighted probability based on the total number of symbols in the set of potential winning symbols.

Published U.S. Patent Application Document No. 20070173312 (Dodge) describes a novel Keno game wherein a player selects up to ten numbers from a field of eighty numbers to be played and these numbers are compared to twenty numbers randomly selected by the game from the same field of numbers in a manner known in the prior art. When the player places one or more conventional bets on the outcome of the game, they now also place one or more side bets as to the number of hits or matches there will be between the player selected numbers and twenty numbers selected by the game computer. The player may place side bets on more than one number of hits or matches to increase their odds of achieving side bet winnings.

Published U.S. Patent Application Document No. 20070197664 (Schultz) discloses a keno game having a bonus round. The keno game provides a player with an additional opportunity to win, after the keno balls have been drawn, to add excitement and volatility to the standard keno game. According to one method, the gaming machine receives the player's input, with the player selecting one or more numbers. A keno draw, which includes a plurality of numbers from a keno pool, is then displayed to the player. A bonus round is initiated in response to a trigger event. The bonus round is a random selection of one or more numbers in addition to the numbers previously selected from the keno draw. The numbers selected from the bonus round are displayed to the player. The numbers selected by the player are evaluated again the numbers from the keno draw results as well as the bonus round, and a payout for any winning outcomes are awarded to the player.

Published U.S. Patent Application Document No. 20060179694 (Thomas) describes a method of playing a keno-type wagering game. The method includes conducting the keno-type wagering game at a gaming terminal. The keno-type wagering game has a plurality of game cards and a plurality of symbols. At least some of the plurality of symbols to be used by a player in the wagering game is displayed to the player. A first set of symbols from the plurality of symbols is selected, and applies to all of the plurality of game cards. The method further includes randomly generating a plurality of second sets of symbols from the plurality of symbols. Each of the plurality of second sets includes a first symbol and each of the first symbols of each of the plurality of second sets is displayed simultaneously. In response to at least one of the symbols of the plurality of second sets matching a symbol from the first set, the player receives an award.

Additional variations in the play of casino games, including Keno are desired in the art. All references cited herein are incorporated in their entirety by reference.

### SUMMARY OF THE INVENTION

A wagering game is played on an electronic system with a processor, memory, a video display screen, value-in-value-out system and a player input system. The processor recognizing a wager, enabling player input at the specific player position. The processor executes code to display two distinct distributional arrays. A first distributional array has 80 selectable alphanumerics in columns and rows, and a second distributional array provides a grid of at least four distinct pairs of linear arrays of frames with at least 40 frames, preferably at least 80 frames for display of a unique symbol or number within each frame of the individual sets of columns, or among all sets of columns in the grid. The processor recognizes degrees or numbers of correspondence along linear relationships between lines or columns in the first and second distributional arrays.

### BRIEF DESCRIPTION OF THE FIGURES

FIG. 1 is a prior art schematic block diagram illustrating a plurality of gaming terminals in communication with a central controller.

FIGS. 2A to 2C are perspective views of one embodiment of prior art gaming terminals useful for the present invention illustrating the player selecting numbers and the gaming terminal generating numbers based on the selected game outcome seed.

FIG. 3 is a schematic of a prior art gaming terminal run by a processor or central processing unit (“CPU”) and a memory device.

FIG. 4 shows a layout of the board played on 81 squares and ball drop provision before and after balls have been called, with the squares rearranged.

FIG. 5 shows a layout of the board played on 80 squares and ball drop provision before and after balls have been called, with the squares rearranged.

FIG. 5A shows a screen shot with both an 80-number Keno Number frame and an 80-number, four pairs of two columns, ball drop area frames and shows one configuration for payline orientations between keno grid areas and ball drop areas on a screen shot.

FIG. 6A shows a distribution of 20 selected numbers with total sum score of each column in three rows of ten columns and a grid of results of selected numbers in three columns of ten rows.

6b FIG. 7 shows an adjustable Odds Chart for selection of combinations of numbers in a racing/bingo/keno event.

FIG. 7A shows a second configuration for payline orientations between keno grid areas and ball drop areas on a screen shot.

FIG. 8A shows an advanced screen shot of 5A displaying correspondence or matches of randomly selected alphanumerics in the first and second distributional arrays for the first two rows.

FIG. 9A shows a screen shot in executing a separate lottery “Race Event” side bet event in which the outcome is determined using a highest ball number in each column in the ball drop area.

FIG. 10A shows a screen shot for row-only matches in another alternative side bet wagering event.

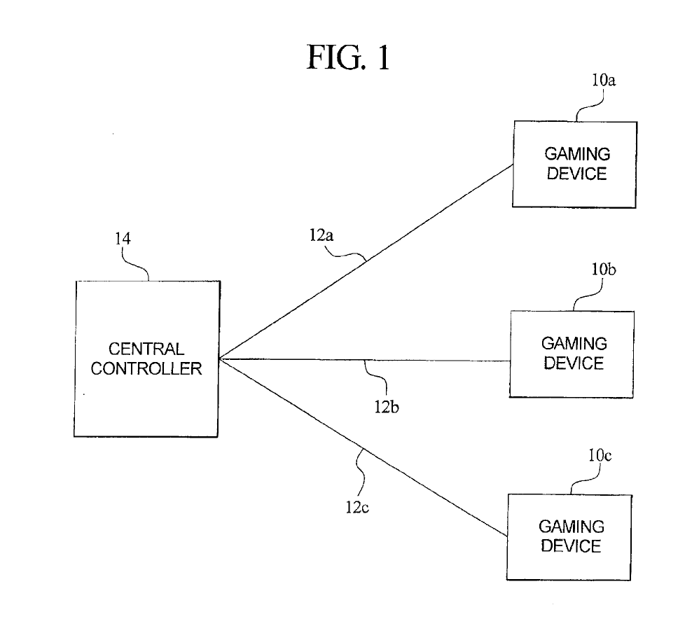

### DETAILED DESCRIPTION OF THE INVENTION

A process and a system enables a process of executing a wagering event, the wagering event being executed on a gaming system comprising a processor, memory, a random number generator, player input controls, value-in-value-out system that establishes wagering credit in the processor and a video display system, wherein:

the processor recognizes a wager of credit input to the processor through the value-in-value-out system at a player input position on a first wagering game;

the processor provides two regions for display of two distinct distributional arrays, a first distributional array of at least 40 selectable alphanumerics in columns and rows, and a second distributional array of frames forming four distinct pairs of linear arrays of frames for collecting at least forty random alphanumeric selections, each pair of the linear arrays aligned with a column or row of the first distributional array;

the processor recognizes positions of all specific alphanumerics in the first distributional array;

the random number generator effecting random distribution of sufficient ones of the random selectable alphanumerics within the second distributional array, thereby filling all or some of the frames forming the four distinct pairs of linear arrays of frames;

the processor determines correspondence of specific alphanumerics in the first distributional array with the ones of the randomly distributed alphanumerics in the second distributional array with respect to the aligned columns and rows; and the processor determining an award payable through the value-in-value-out system as a winning credit, a push or a loss of credit on the recognized wager against a paytable dependent on the determined correspondence of specific alphanumerics in the first distributional array with the ones of the randomly distributed alphanumerics in the second distributional array with respect to the aligned columns and rows.

The method may have the processor provide a first distributional array of at least 80 selectable alphanumerics in ten columns and eight rows and a second distributional array of 80 frames forming four distinct pairs of linear arrays of 10 frames in each linear array for collecting at least twenty random alphanumeric selections, each pair of the linear arrays aligned with a column or row of the first distributional array. The method may also have the processor use an entire set of eighty selectable alphanumerics used to fill all frames in the four distinct pairs of linear arrays of 10 frames in each linear array for collecting at least twenty random alphanumeric selections, or the processor uses distinct and separate sets of eighty selectable alphanumerics to fill all frames in each of the four distinct pairs of linear arrays of 10 frames in each linear array for collecting at least twenty random alphanumeric selections. In a preferred event, the alphanumerics comprise a set of numbers from 1 to 80 inclusive.

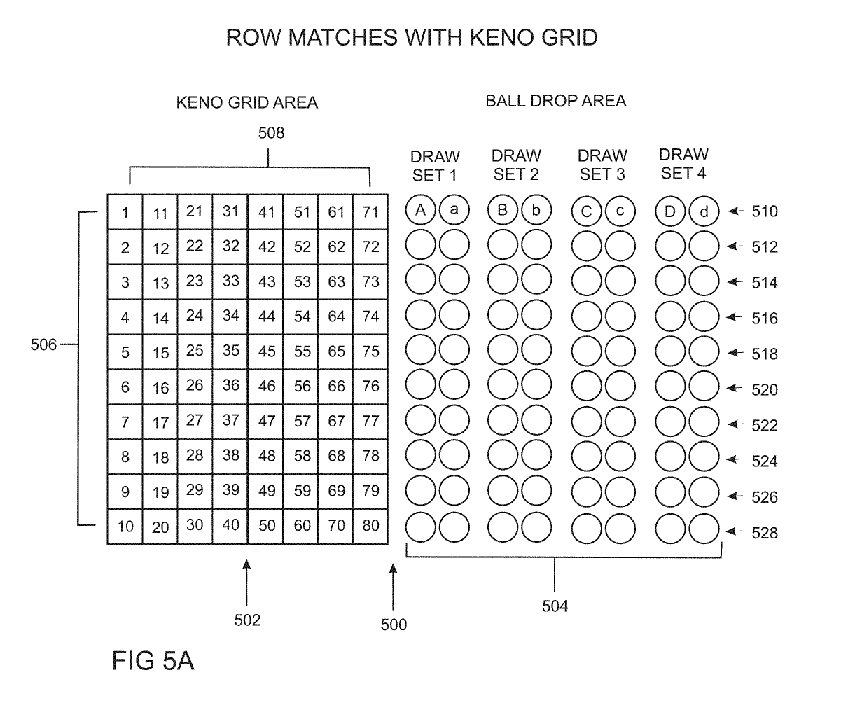

FIG. 5A shows a screen shot 500 of a format for execution of an underlying gaming event according to the present technology. The first set of total available alphanumerics for wagering 502 is shown with 10 rows 506 (beginning with 1, 2, 3, 4, 5, 6, 7, 8, 9, and 10 in first column frames) and 8 columns 508 (beginning with first row numbers of 1, 11, 21, 31, 41, 51, 61 and 71) within a dedicated area 502 on the screen shot 500. The top row, beginning with “1” and continuing horizontally is aligned with a first set of four pairs of fillable frames 510. The pairs are respectively filled in with random numbers, and the pairs of frames in each pair set are labeled A a, B b, C c, and D d in the four pairs. The pairs in the ball drop area 504 of the four pairs of linear arrays will be referred to by the starting frame pairs such as Ball Drop areas 504 of Column Aa, Bb, Cc and Dd, respectively. When the random number generator (RNG not shown) assists the processor (not shown) in filling the frames in the respective pairs of the ball drop area 504, the individual frames may be filled in various ways. In a first method, the RNG randomly selects one single number from an original set of at least 80 numbers until eighty numbers (the number necessary to fill all eighty frames in the ball drop area 504) are filled. The eighty numbers randomly selected may be used to first fill one or both sides of Column Aa first, and then progress through columns Bb, Cc and Dd sequentially or random numbers selected are randomly distributed among columns Aa, Bb, Cc and Dd until all frames are filled.

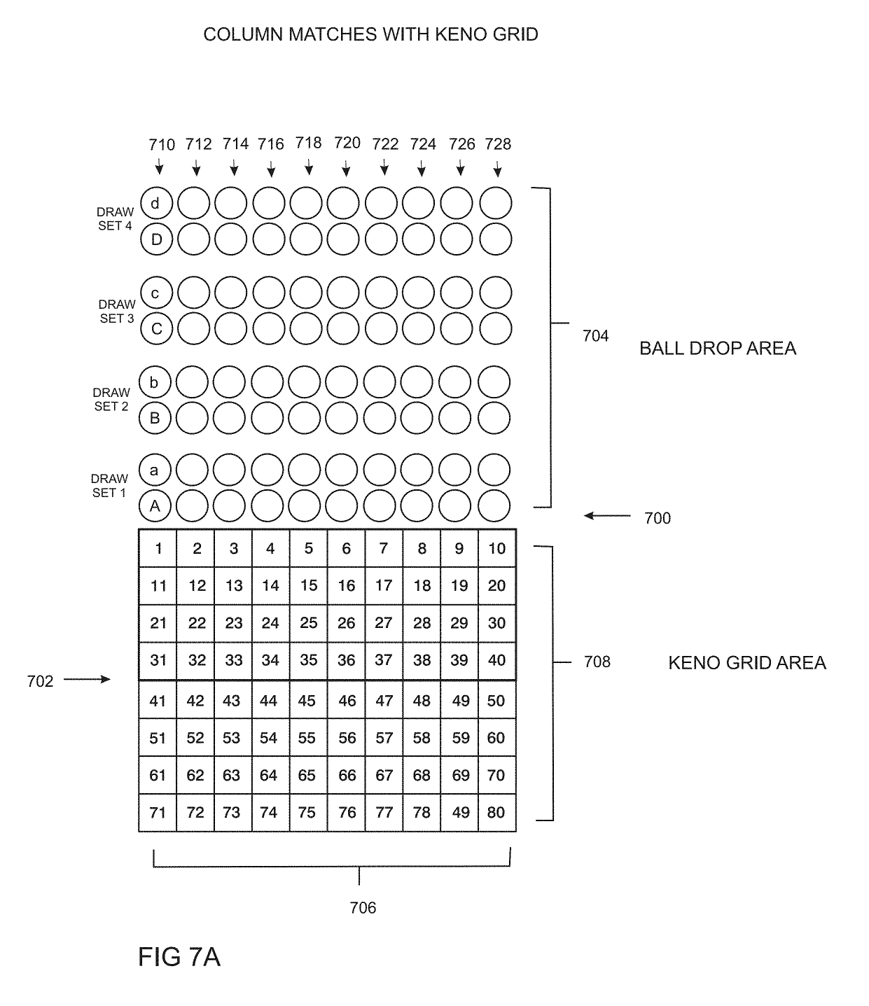

Alternatively, each pair of columns will have its own set of 80 numbers from which the random number generator will select sufficient alphanumerics (e.g., numbers) to fill the 20 frames within each pair of columns in the draw sets. In that way, all eighty alphanumerics are available for each draw set, and therefore events may be executed or wagered on where matching of hits in the four different draw sets can be an outcome event by which the wager can be determined. The aspect of the invention that is particularly important in this regard for enabling novel gaming events is the provision of what is labeled in FIG. 5A as the Keno Grid Area 502 and the four columns of pairs of frame arrays in the Ball Drop Area 504. As shown in FIG. 7A, the Keno Grid Area 702 and the Ball Drop Area (704, but above the Keno Grid Area 702) columns of pairs as 710 712 714 716 718 720 724 726 and 728 are oriented differently with respect to the Keno Grid Area 702. This rearrangement of orientation allows for different visual perspectives and alternative wagering events.

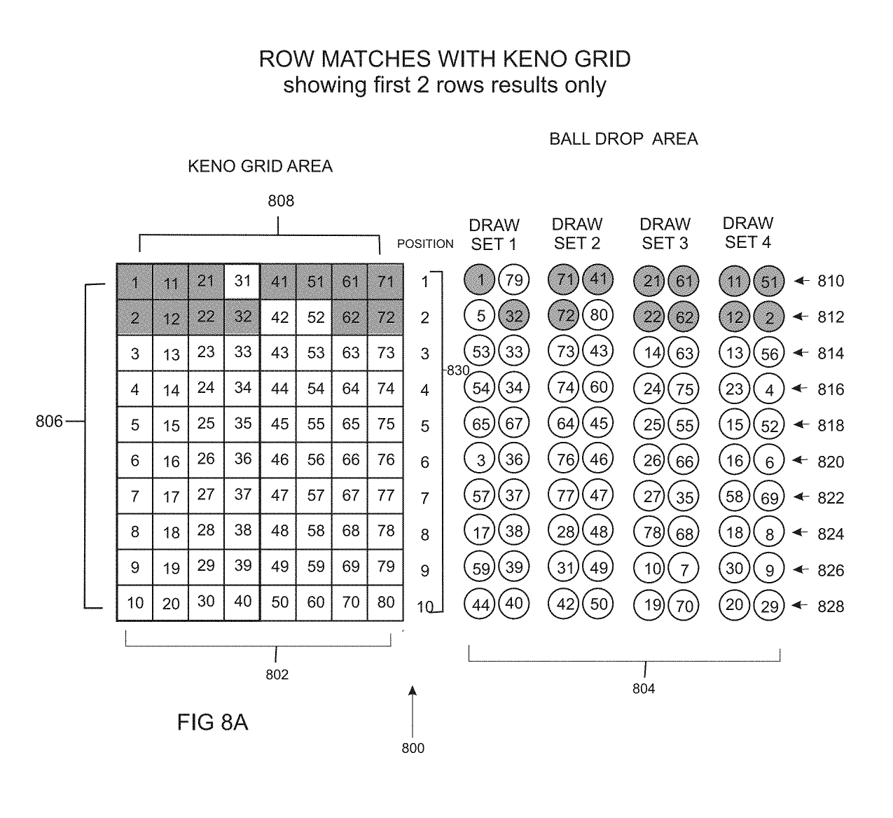

Looking at FIG. 8A, an advanced screen shot 800 of the screen shot 500 of FIG. 5A is shown with all frames in all four Draw Sets (Set 1, Set 2, Set 3 and Set 4) filled with the eighty available alphanumerics from a single set of 80 numbers (1 . . . 80). With the frames filled entirely with exactly eighty numbers, a number of different wagering events can be executed on the same final display. A simple first example is wagering on individual columns, multiple columns or all columns on numbers of “matches” among frames in the rows (810, 812, 814, 816, 818, 820, 822, 824, 826 and 828) of the Draw Sets and the position lines 830 (1, 2, 3, 4, 5, 6, 7, 8, 9 and 10) in the Keno Grid Area. For example, looking at the position lines and their corresponding rows in the Draw Set, matches can be seen in row 810, as with “1” in the Keno grid and the “1” in Draw Set 1, as well as (71, 41), (21, 61), (11 and 51) in Draw Sets 2, 3 and 4, respectively, as well as 32, 72, 22, 62, 12 and 2 in row 812, and numerous other rows (810 . . . 828) and their corresponding position rows (1 . . . 10) in the Keno Grid Area. Original wagers in the wagering event may be placed on all rows and position lines in the Ball Drop Area and Keno Grid Area, or on Ball Drop Lines (any ones of 810 . . . 828) or any Keno Grid Area position lines (1 . . . 10), or on any, multiple, or all Ball Drop Area Draw Sets (Sets 1 . . . 4). Paytables are established with payout amounts determined by numbers of matches or degrees of correspondence between frames and alphanumerics in position lines in the Keno Grid Area and rows in the Ball drop Area.

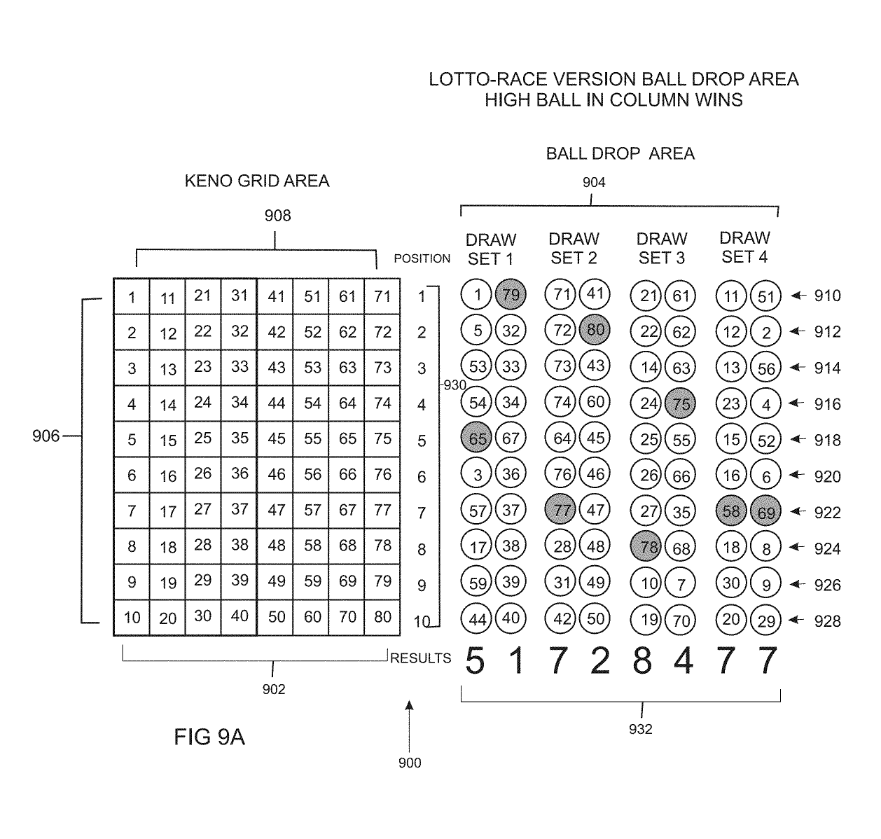

These methods and system may be used as a single game or be used with side bets in addition to the underlying game on the system. For example, looking at FIG. 9A, wagering outcomes can be based on a system for interpreting the results and final distribution of random selectable alphanumerics within the frames in the four distinct pairs of linear arrays. In a first method, a wager could be made on any or any combination of the columns or pairs of columns known as draw sets with the winning outcome being the row or position in which the highest alphanumeric for each column or pair of columns landed. For example, in FIG. 9A, the highest value alphanumeric in the first column of the second distributional array, “65”, landed in row 5 or position 5. The winner for the wagering event in that column is “5”. Similarly, wagers could be offered on any or any combination of the rows or positions with the winning outcome being the column within each row hosting the highest value alphanumeric. For example, in FIG. 9A, the highest value alphanumeric in the first row of the second distributional array, position 1, is “79” which falls in the 2^{nd} column. The winner for the wagering event in that row is “2” or “a” as the column is labeled in FIG. 5A. Furthermore, these outcomes for column or row winners, can be used in sequence to create a lottery or progressive event. For example, in section 932 of FIG. 9A, the results for the highest value row or position of each column are shown below the second distributional array forming a lottery number of “5-1-7-2-8-4-7-7”. That number will form the basis of a lottery or progressive event won by a player purchasing a ticket or getting a separate random number equivalent to or having a predetermined number of corresponding numbers, either in sequence or collectively. For example, a player at a bank of these keno games may have a random number good for one game, or over the course of a fixed period of time (e.g., one hour, six hours, twelve hours, twenty-four hours, a specific number of days, a week, or even indefinitely until a winning lottery or progressive event is achieved). Alternatively smaller jackpots or smaller awards could be achieved by having each pair of columns determine only a single number, so that one or two four-number final WINNING NUMBERS events occur. This can produce smaller awards with higher hit frequencies. Winning outcomes for wagers on the WINNING NUMBERS may also be paytable based such as having a wager on a game event number with correspondence to the WINNING NUMBER outcome of at least two or three numbers required for a minimum payout, and payouts increasing to a maximum with more matches.

In a second method, wagers could be offered on the entire column set, the entire row set, or all sets of pairs of linear arrays in a manner similar to a horse race. Each column, row, or pair of linear arrays would receive a score which is equal to it's highest alphanumeric. These scores would be compared to the scores of all of the other columns, rows, or pairs of linear arrays and they would be ranked first through last place with first place being the column, row, or pair of linear arrays with the highest score. Wagers could be accepted on predicting the winner, first 2, first 3, or even predicting the entire ranking.

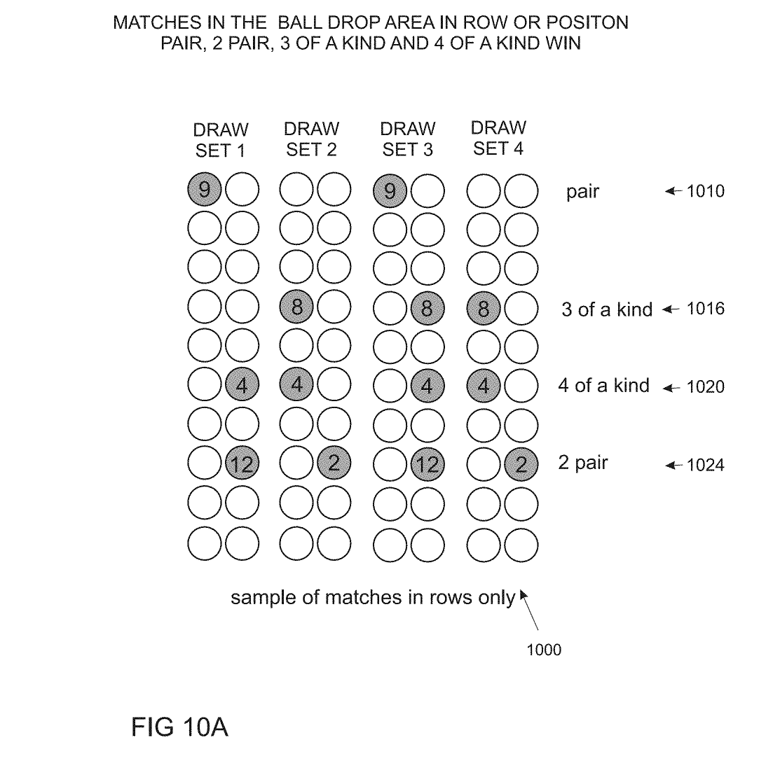

In a third method, as shown in FIG. 10A, when the processor uses distinct and separate sets of eighty selectable alphanumerics to fill all frames in each of the four distinct pairs of linear arrays, another side wager can be offered based on correspondence of alphanumerics in a particular row (as shown in FIG. 5A) or particular column (as shown in FIG. 7A) across the draw sets or pairs of linear arrays. In FIG. 10A, it is shown that a 9 was randomly distributed to the top row or position 1 of both draw sets 1 and 3 giving that row one pair of alphanumerics (1010). Another example can be seen in row or position 4 which had the alphanumeric “8” randomly distributed to draw sets 2, 3, and 4 creating a “3-of-a-kind” for that row (1016). Further examples in FIG. 10A show a “4-of-a-kind” in row 6 (1020) and “2 pair” in row 8 (1024). Paytables could incorporate many traditional poker hand values such as those mentioned above plus straights or consecutive alphanumerics.

It will be readily apparent that the various methods and algorithms described herein may be implemented by, e.g., appropriately programmed general purpose computers and computing devices. Typically a processor (e.g., one or more microprocessors) will receive instructions from a memory or like device, and execute those instructions, thereby performing one or more processes defined by those instructions. Further, programs that implement such methods and algorithms may be stored and transmitted using a variety of media (e.g., computer readable media) in a number of manners. In some embodiments, hard-wired circuitry or custom hardware may be used in place of, or in combination with, software instructions for implementation of the processes of various embodiments. Thus, embodiments are not limited to any specific combination of hardware and software

A “processor” means any one or more microprocessors, CPU devices, computing devices, microcontrollers, digital signal processors, or like devices.

The term “computer-readable medium” refers to any medium that participates in providing data (e.g., instructions) that may be read by a computer, a processor or a like device. Such a medium may take many forms, including but not limited to, non-volatile media, volatile media, and transmission media. Non-volatile media include, for example, optical or magnetic disks and other persistent memory. Volatile media include DRAM, which typically constitutes the main memory. Transmission media include coaxial cables, copper wire and fiber optics, including the wires that comprise a system bus coupled to the processor. Transmission media may include or convey acoustic waves, light waves and electromagnetic emissions, such as those generated during RF and IR data communications. Common forms of computer-readable media include, for example, a floppy disk, a flexible disk, hard disk, magnetic tape, any other magnetic medium, a CD-ROM, DVD, any other optical medium, punch cards, paper tape, any other physical medium with patterns of holes, a RAM, a PROM, an EPROM, a FLASH-EEPROM, any other memory chip or cartridge, a carrier wave as described hereinafter, or any other medium from which a computer can read.

Various forms of computer readable media may be involved in carrying sequences of instructions to a processor. For example, sequences of instruction (i) may be delivered from RAM to a processor, (ii) may be carried over a wireless transmission medium, and/or (iii) may be formatted according to numerous formats, standards or protocols, such as Bluetooth™, TDMA, CDMA, 3G, 4G.

Where databases are described, it will be understood by one of ordinary skill in the art that (i) alternative database structures to those described may be readily employed, and (ii) other memory structures besides databases may be readily employed. Any illustrations or descriptions of any sample databases presented herein are illustrative arrangements for stored representations of information. Any number of other arrangements may be employed besides those suggested by, e.g., tables illustrated in drawings or elsewhere. Similarly, any illustrated entries of the databases represent exemplary information only; one of ordinary skill in the art will understand that the number and content of the entries can be different from those described herein. Further, despite any depiction of the databases as tables, other formats (including relational databases, object-based models and/or distributed databases) could be used to store and manipulate the data types described herein. Likewise, object methods or behaviors of a database can be used to implement various processes, such as the described herein. In addition, the databases may, in a known manner, be stored locally or remotely from a device that accesses data in such a database.

Some embodiments can be configured to work in a network environment including a computer that is in communication, via a communications network, with one or more devices. The computer may communicate with the devices directly or indirectly, via a wired or wireless medium such as the Internet, LAN, WAN or Ethernet, Token Ring, or via any appropriate communications means or combination of communications means. Each of the devices may comprise computers, such as those based on the Intel® Pentium® or Centrino™ processor, that are adapted to communicate with the computer. Any number and type of machines may be in communication with the computer.

The present disclosure provides, to one of ordinary skill in the art, an enabling description of several embodiments and/or inventions. Some of these embodiments and/or inventions may not be claimed in the present application, but may nevertheless be claimed in one or more continuing applications that claim the benefit of priority of the present application. Applicants intend to file additional applications to pursue patents for subject matter that has been disclosed and enabled but not claimed in the present disclosure.

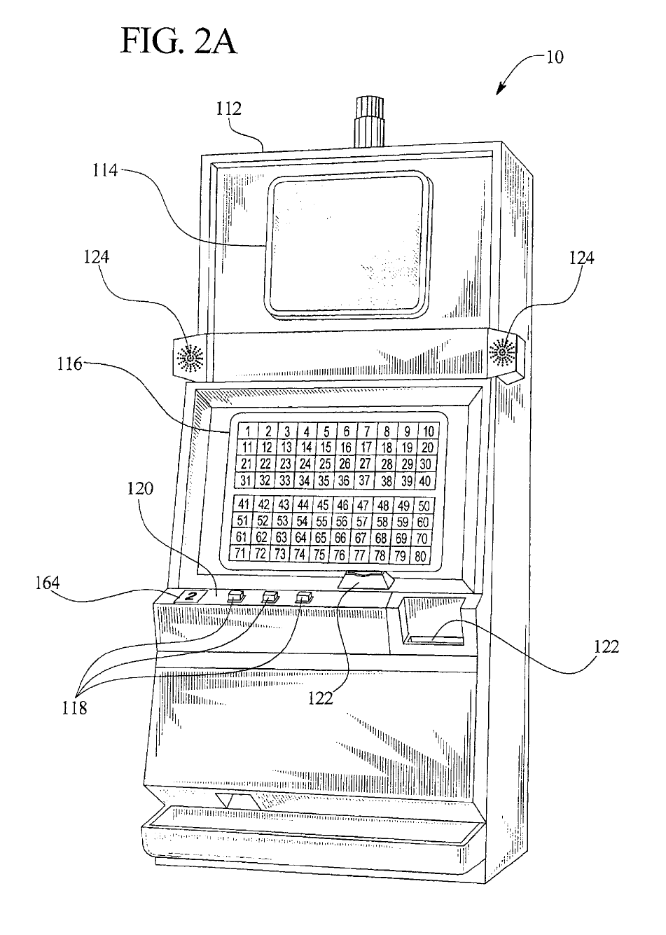

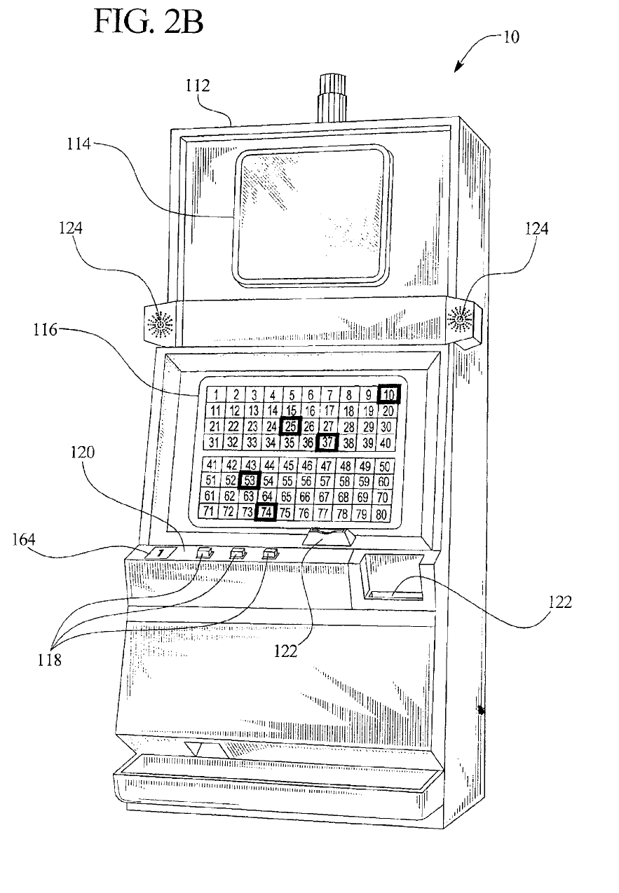

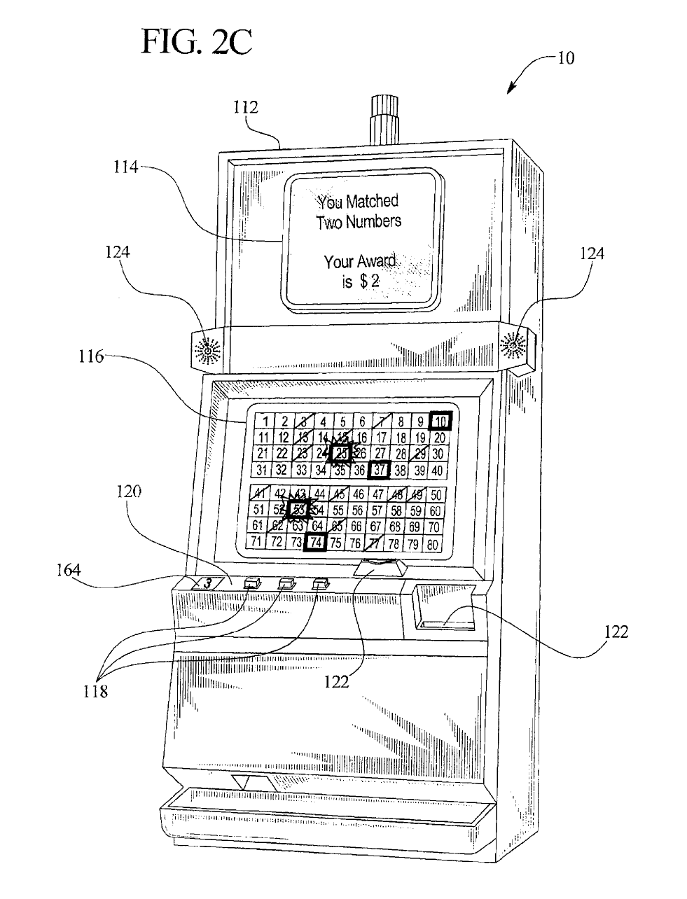

Referring now to FIGS. 2A to 2C, each of the embodiments described herein is provided in one preferred embodiment in a gaming terminal 10. Alternatively, the embodiments are provided on various monitors throughout a casino or gaming establishment, including traditional Keno boards and electronic terminals and video gaming equipment. Gaming terminal 10 is in one embodiment a video gaming device and includes a cabinet 112 having at least one video monitor. The illustrated embodiment includes two video monitors 114 and 116. Cabinet 112 is illustrated as being of a type where the player stands or sits. The cabinet is alternatively a bar top cabinet, wherein the player sits to play the Keno game of the present invention.

The cabinet 112 also provides controls for a player to operate gaming terminal 10. In the illustrated embodiment, various electromechanical input devices 118 are provided on a tilted portion 120 of the cabinet 112, below video monitors 114 and 116. Electromechanical input devices 118 each send a discrete signal to a microprocessor located within cabinet 112. These input devices enable the player to perform the various Keno functions, including but not limited to, selecting at least one of the Keno numbers or game choices, playing multiple games at once, wagering a number of credits per game and cashing out. The input devices 118 may also enable the player to play multiple Keno games in a row.

Similar to the electromechanical input devices 118, cabinet 112 of gaming terminal 10 can provide electromechanical displays that show, for example, the player's credits maintained within gaming terminal 10, the number of Keno numbers played, the bet per game, etc. In one preferred embodiment, however, these functions as well as others are provided on one or more video monitor or display devices 114 and 116. In one embodiment, display device 114 may show the pays for a number of hits or matches between the numbers or game choices that the player selects and the numbers or game choices that gaming terminal 10 marks or illuminates. Displays 114 and 116 can also inform the player of the rules concerning the operation of the Keno game of the present invention.

Video monitors 114 and 116 display, among other items: (i) the Keno numbers or game choices generated by the gaming terminal 10 based on the game outcome seed; (ii) the modified Keno numbers or game choices; (iii) the numbers played by the player; (iv) the wager per game; (v) the player's total wager and (vi) the player's Keno award, if any. In one embodiment, credit display 164 displays the player's accumulated credits. In one embodiment, when the player selects a number or game choice, gaming terminal 10 highlights it as a certain color, for example, yellow. When the gaming device generates a number or game choice or uses the bidirectional map to modify a number or game choice, gaming terminal 10 highlights it as a different color, for example, blue. When a match occurs, the number is highlighted by a third color, for example, green, a combination of blue and yellow.

Cabinet 112 of gaming terminal 10 also includes one or more monetary input devices 122. The monetary input device 122 can accept coins, cash, a smart card, a credit card, a debit card, a casino card, ticket-in/ticket out wagering/accounting systems or other type of gaming device card. Keno gaming terminal 10 can also include a ticket reader and a ticket printer (not illustrated) that enables the player to input and receive a redeemable ticket in lieu of cash. The ticket reader/validator and printer operate with a processor housed inside gaming terminal 10.

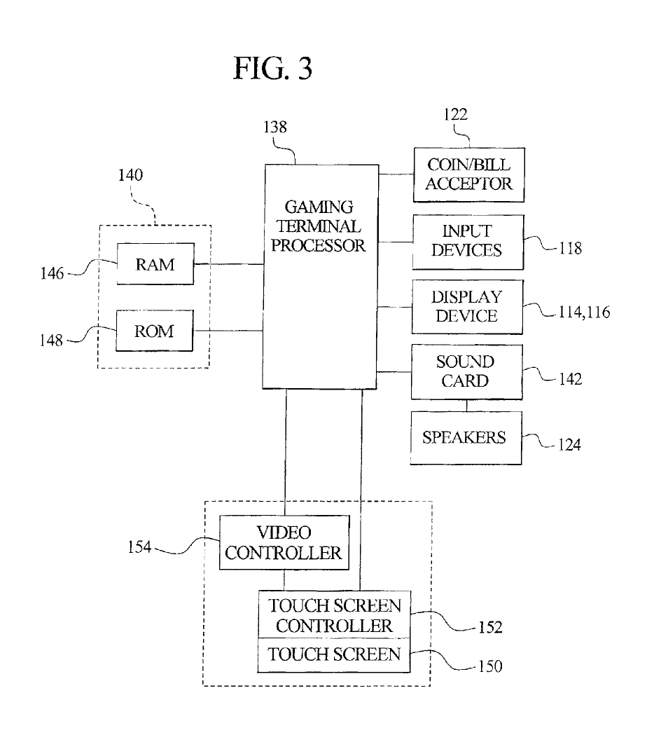

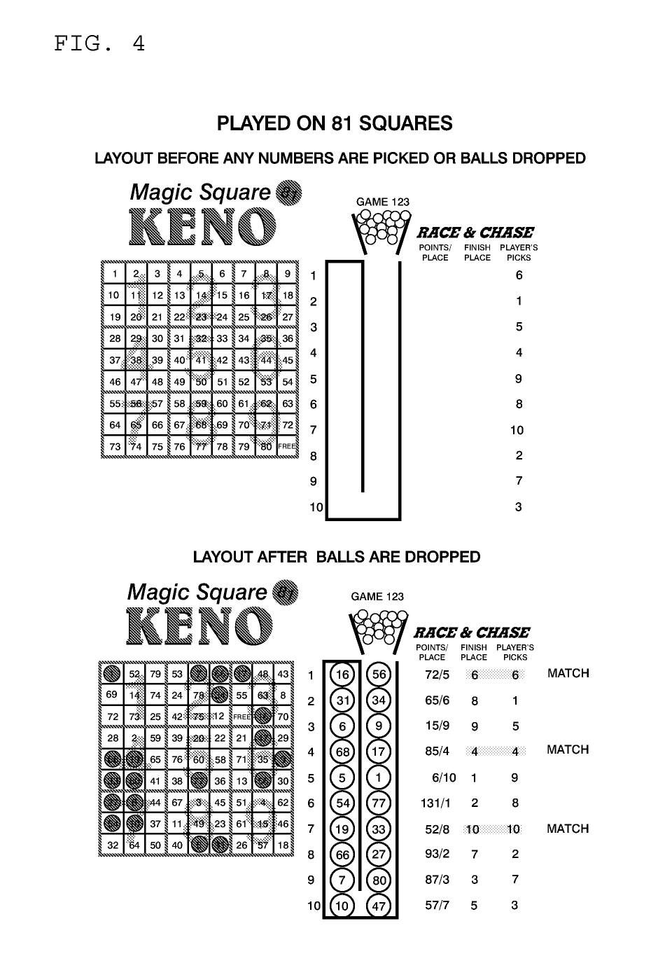

Referring now to FIG. 3, gaming terminal 10 is run by a processor or central processing unit (“CPU”) 138 and a memory device 140 that operates with one or more display devices 114 and 116 that display the generated Keno numbers. Processor 138 can be a microprocessor and have a microcontroller-based platform. The processor 138 is operable with a communication device which is in communication with the central controller. The memory device 140 includes random access memory (“RAM”) 146 and read only memory (“ROM”) 148. The platform for the processor 138 and memory device 140 can be: (i) inside gaming terminal 10; or (ii) as stand alone components in the casino, part of a server/client system, data network, one or more application-specific integrated circuits (ASIC's), field programmable gated arrays (FPGA's) or one or more hard-wired devices. Furthermore, although the processor 138 and memory device 140 preferably reside on each gaming terminal 10 unit, it is possible to provide at least the function of selecting a game outcome seed (that is deterministic of a game outcome) from a pool or set of game outcome seeds, at a central location by a central controller such as a network server for communication to a playing station such as over a local area network (LAN), wide area network (WAN), Internet connection, microwave link, and the like.

Cabinet 112 of gaming terminal 10 also provides a number of speakers 124 that operate via a soundcard 142 with processor 138 to inform the player of any type of output, outcome or instruction of gaming terminal 10.

Gaming terminal 10 provides an electromechanical input device 18 or simulated input device provided by a touch screen 150 that operates via a touch screen controller 152 and a video controller 154 with the processor 138. The input devices enable the player to operate the Keno gaming terminal 10 of the present invention. One of the video monitors 114 and 116 and possibly, additionally the speakers 124 are used to explain: (i) when . . . ; (ii) how many . . . ; (iii) how much; and (iv) the type of award provided for obtaining the required number of matches.

The Keno game of the present invention can include any suitable variation of Keno. For purposes of the present invention, the game is illustrated in combination with the variation sometimes referred to as ‘horse race’ or Nevada Keno. In this Keno game, one or more players play against the house.

In addition to winning base game credits, the gaming terminal 10, including any of the base games disclosed above, also includes secondary or bonus games that give players the opportunity to win credits. The gaming terminal 10 preferably employs a video-based display device 130 or 132 for the secondary or bonus games. The secondary or bonus games include a program that automatically begins when the player achieves a qualifying condition or a secondary game triggering outcome in the base game, such as a certain number of matches, a specific number matched or a any other suitable triggering event.

The game play of the keno game of the present invention is initiated by a player inserting the appropriate amount of money or tokens at one of the plurality of gaming terminals in communication with the central controller. The gaming terminal enables the player to push one of the electromechanical pushbuttons or touch the touch screen that operates with the display device to select one or more numbers or game choices to play from a plurality of different player selectable numbers or game choices. It should be appreciated that while numbers are used to describe the present invention, any other suitable game choice such as symbols, images or indicia may be implemented with the keno game of the present invention.

A method of playing a keno-type wagering game, the method comprising: conducting the keno-type wagering game at a gaming terminal, the keno-type wagering game having a plurality of game cards (e.g., the traditional 81 or 80 or without a free space) or the subset of smaller cards within the total number card of 80 or 81, as further described herein) and a plurality of symbols; displaying at least some of the plurality of symbols to be used by a player in the wagering game; selecting a first set of symbols from the plurality of symbols, the first set of symbols applying to all of the plurality of game cards; and randomly generating a plurality of second sets of symbols from the plurality of symbols, wherein each of the plurality of second sets includes a first symbol and each of the first symbols of all of the plurality of second sets are displayed simultaneously, and wherein each of the plurality of second sets of symbols corresponds to one of the plurality of game cards; in response to at least one of the symbols of the plurality of second sets matching a symbol from the first set, awarding the player a winning award.

The present technology may be described as including at least a method of playing a wagering game on a system comprising a processor, a video display screen and a player input system. This general method may include steps of:
a processor recognizing a wager placing value at risk at a specific player position;
the processor allowing player input at the specific player position where a wager has been recognized so that symbol selections in the play of the wagering game may be recognized at that specific player position;
the processor executing code to display a grid of 9×9 frames to provide frames for display of symbols in the wagering game and displaying a unique symbol within each frame of the grid;
the processor recognizing selection of either at least three specific frames or at least three specific symbols at the specific player position from the player input system at that specific player position;
the processor executing code to randomly select a) at least 10 symbols from a set of at least 80 separate and distinct symbols or b) at least 10 frames from the grid;
the processor executing code to compare recognized at least three symbols or at least three frames at the specific player position with the at least 10 symbols or at least 10 frames randomly selected by the processor;
the processor resolving the wager placing value at risk on a basis of degree of correspondence between the at least three symbols or at least three frames at the specific player position with the at least 10 symbols or at least 10 frames randomly selected by the processor.

The method may generally include at least steps wherein A) the processor executes code to display a first arrangement of unique symbols within each frame prior to recognizing selection at the specific player position, and B) the processor executes code to display a second arrangement of the same unique symbols after recognizing selection at the specific player position and before resolving the wager, the first arrangement of symbols being different from the second arrangement of symbols with respect to distribution of symbols among the frames.

The method may be practiced wherein each frame of the grid has a unique 1 of 80 symbols displayed therein in the first arrangement, and/or wherein there is a single inactive symbol in a single frame of the grid in the first arrangement, and/or wherein the processor recognizes only selection of specific symbols at the player position and the processor executes code to randomly distribute the same unique symbols in step B), and/or wherein the processor executes code to select at least 20 symbols from the set of at least 80 separate and distinct symbols.

The method may also allow the processor to execute code to select at least 20 symbols from the set of at least 80 separate and distinct symbols. The method may also allow the processor to execute code so that one frame is occupied by an inactive symbol separate from the at least 80 symbols.

The method may be practiced wherein the processor recognizes a second wager placing a second value at risk at a player position in which a wager is made on at least three frames within a contiguous 3×3 grid within the 9×9 grid, and the second wager is resolved on a basis of degree of correspondence between the at least three frames at the specific player position with the at least 10 symbols randomly selected by the processor. Alternatively the processor recognizes a second wager placing a second value at risk at a player position in which a wager is made on at least three frames within any number of contiguous 3×3 grids (either 1 grid, up to 9 grids, or even non-patterned grids, such as rather than spaces 1-3, 10-12 and 20-22 forming a first 3×3 grid in an upper left section of a 9×9 grid, wagering on frames 2-4, 11-13 and 21-23 within the 9×9 grid) within the 9×9 grid, and the second wager is resolved on a basis of degree of correspondence between the at least three frames at the specific player position with the at least 10 symbols randomly selected by the processor or the processor recognizes a second wager placing a second value at risk at a player position in which a wager is made on at least three symbols appearing within a specific contiguous 3×3 grid within the 9×9 grid, and the second wager is resolved on a basis of degree of correspondence between the at least three symbols at the specific player position with the at least 10 symbols randomly selected by the processor. In playing the full card or small-card (e.g., 3×3 bingo variant of the keno game, there are at least two options for play. A1 credit wager may cover all 3×3 grids; and if any of 3×3 grids have a valid bingo pattern after the 20 symbols are selected, the player will win (lower payouts) based on the number of 3×3 grids with valid bingos. Although the “free space” in a 9×9 keno card is usually an inactive space (although it may be a truly free “winning” space in a 3×3 pick, especially when all nine possible 3×3 sub-cards are selected) as its location becomes random), it may be an inactive frame in the keno games, but may be a “free space” in any wagers that include the bingo variant.

Alternatively, Players can wager 1-9 (or more) credits on specific bingo cards (including the individual 3×3 bingo cards) as you would wager the desired number of credits on lines in a slot machine). If a Player wagered on Cards 1-3 only, and card 4 had a valid bingo, the player would NOT win.

As a still further alternative, the processor recognizes a third class of wager in which the processor executes code to compare numbers or value of symbol correspondence in nine contiguous 3×3 grids, and the recognized third wager selects ones of the nine contiguous grids for numbers or value of corresponding symbols as compared to other ones of the nine contiguous grids, and the processor resolves the third recognized wager for accurate selection at least one contiguous grid with respect to numbers or value of corresponding symbols as compared to other ones of the nine contiguous grids. In this last mode of play, the processor may execute code to compare the nine grids in order of greatest number or value of corresponding symbols within each of the nine grids at least in a first highest, second highest and third highest order of correspondence within 3×3 grids and resolving the third wager based on processor recognized first highest, second highest and third highest order of correspondence within 3×3 grids and resolving the third wager based on a processor recognized third wager on first highest, second highest and third highest order of correspondence within 3×3 grids. The order of finish in the individual grids may be likened to Win, Place and Show wagers in a horse race. In the race variant, where players have identified an order of “finish” for total absolute value of symbol matches within respective 3×3 grids, or that total absolute value is used to break ties between or among grids with identical numbers of symbols in correspondence with the randomly processor selected symbols, the total absolute value of the matched symbols may be a component of the award. That is, where frames have been originally selected, the frames are randomly filled with numbers, the processor randomly selects numbers, and the randomly selected numbers are compared with the numbers in the randomly filled frames or squares, the actual numeric values (e.g., 3, 9, 46, 65, 78, etc.) may be added within the 3×3 squares as a comparative feature, either for breaking ties or paying a special award (e.g., when a 3×3 grid has an absolute numeric total in excess of a predetermined number (such as, for example, >150, >160, 175, etc.). In the race variant, this is a convenient way for breaking ties. If a tie still exists, the tie could be finally broken by another evaluation of the grid that contains the lowest matched number, the highest matched number and/or the free space.

For example, in this last wager event, the nine grids may be identified as 1, 2, . . . 9 or A, B, . . . J and the player may make such various wagers on the relative order of finish as C in first place (a Win bet), F in second place (a Place bet), I in third place (a Show bet), A in first place and E in second place (a Perfecta) or B in first place, A in second place and J in third place (a Trifecta wager), or other specific combinations of relative position wagers.

Additionally, in addition to wagering on win, place, show, exacta, and trifecta, game play could offer the option to place all 9 grids in a predicted finish order. For example: 1^{st}—G; 2^{nd}—A, 3^{rd}—F, 4^{th}—B, 5^{th}—C, 6^{th}—D, 7^{th}—E, 8^{th}—I, 9^{th}—H. Wins would be based on the number correctly predicted. If Grid A did come in 2^{nd} and Grid C did come in 5^{th}, but all other grids came in a different finish order, the player would have 2 hits and be paid accordingly.

Side Bet Games Playable with the Keno Games Format

The side bet technology of the Race and the Chase games may be played on systems and methods as described herein. A gaming system used may have a processor, player input position and a video display system, wherein:
the processor is configured to execute code to recognize a wager at a player input position on a first wagering game;
the processor is configured to recognize and display on the video display system randomly selected alphanumerics, wherein the randomly selected alphanumerics are used in outcome determination in an underlying wagering game selected from the group consisting of bingo, keno and variants of bingo and keno;
the processor displaying the randomly selected alphanumerics on the screen to display outcome results for the underlying wagering game;
the processor also displaying the randomly selected alphanumerics on the screen in a separate two-row or two-column array of paired individual randomly selected alphanumerics
the processor ranking paired individual randomly selected alphanumerics on a basis of total summed values for paired individual randomly selected alphanumerics; and
the processor executing code to resolve the wager at the player input position on the first wagering game based upon the ranking paired individual randomly selected alphanumerics.

The gaming system may use between 1 and 12 pairs of ranking paired individual randomly selected alphanumerics displayed and used in determining outcomes for the first game. For example, if a single Win event is selected, only a single Pair of individual randomly selected alphanumerics need be displayed, although this would require some level of trust by a player on the integrity of the system. Where two pairs are used, the pay back might have to be lowered to 6:5, 7:5; 8:5 or 9:5, so that there is a reasonable house return. It is more likely that at least three, at least four, at least 5, six, seven, eight, nine or at least ten pairs are used as described herein. The gaming system may be preferred where between 1 and 12 pairs of ranking paired individual randomly selected alphanumerics are used in determining outcomes for the first game and between 3 and 40 pairs of ranking paired individually selected random alphanumerics are displayed on the video display system. The gaming system may be used in conjunction with an underlying game of bingo or keno and physical balls are randomly selected and electronic signals of the physical balls selection outcomes are provided as signals to the processor to enable the processor to recognize balls selected as randomly selected alphanumerics. The gaming system may have an underlying game of keno or bingo and virtual bingo or virtual keno balls are randomly selected by a random number generator and electronic signals of the virtual balls selection outcomes are provided as signals to the processor to enable the processor to recognize balls selected as randomly selected alphanumerics. The gaming system may have the player input position be a terminal with a wager selecting system selected from the group consisting of buttons and touchscreens. Newer technology may allow for voice recognition, use of PDA's, smart phones, smart pads, distal connection through a processor (laptop or system computer), connection may be through the internet in wireless systems, banked systems, multi-player systems and the like. The gaming system may use exactly 20 ball selections as the randomly selected alphanumerics and the 20 ball selections are displayed on the video display system as two columns of selections or two rows of selections of from 3 to 10 pairs of ball selection values. The gaming system may be practiced wherein the ball selections have number values associated with each ball, the processor executes code to a) display individual number values within racing positions on an array; b) sum number values within each racing position; and c) the processor executes codes to rank racing positions with respect to largest summed number values.

A method of playing a side bet wagering game according to the present technology may include:
a wager on a game is received by a wager resolver;
a random set of 20 numbers is provided by the wager resolver;
the random set of numbers is organized by the wager resolver into two columns or two rows of number pairs;
the wager resolver sums the sets of numbers in the number pairs to form a number pair total outcome;
the wager resolver orders the number pair outcomes in accordance with an order of highest number pair total outcome to lowest total number pair outcome; and
the wager resolver resolves the side bet wager on correspondence of the ordered number pair outcomes to a preselected number pair outcome associated with the wager on the game.

Note that all activity required in this method is performed by the wager resolver that may be any combination of physical dealer, croupier, processor, game controller and the like. The random set of 20 numbers may be provided by random selection of physical balls or random number generator selected virtual balls. There may be physical balls used in an underlying game of keno or bingo that are used by the wager resolver to provide the random set of 20 numbers. The method may use virtual balls in an underlying game of keno or bingo are provided by a processor performing as the wager resolver to provide the random set of 20 numbers, and the processor executes code to display the 20 numbers and to resolve the wager on the game.

It is assumed that a twenty-ball game of keno is being played, but smaller or larger numbers of balls may be used in the play of the side bets and smaller or larger keno game boards may be used as compared to the standard keno boards described above. The game may also be played with or without the randomization of numbers within frames of the keno board as described above.

In one side bet variant, the (assumed) twenty selected game balls are deposited into a 2×10, 10×2, 4×5 or 5×4 grid. Even six 3× grids may be provided with a separate 2× array, providing 7 different sets of “ordered” balls that have been selected. Furthermore, additional grids may be used such as Row 1 receiving only one ball, Row 2 receiving 2 balls, Row 3 receiving 3 balls, etc. creating a new set of pay tables based on which rows are selected. Rows with more balls may receive lower pay outs, while rows with less balls would receive higher payouts if the player receives a winning outcome on their wager. This deposition of the balls (e.g., in order of selection or randomly) creates arrays of balls in an identifiable order. Typically the “order” of the balls is read from left to right, but a right to left, top-to-bottom or bottom-to-top order of the balls may be used. If other numbers of randomly selected balls are used for the game, other grids may become available such as a game using 21 balls with a 3×7 delivery grid.

An example of this “Race and Chase” type game will be described with respect to the 2×10 set of arrays, with the understanding that the format may be varied with respect to the other grid arrays with minimal structural or software variation in the play of the game.

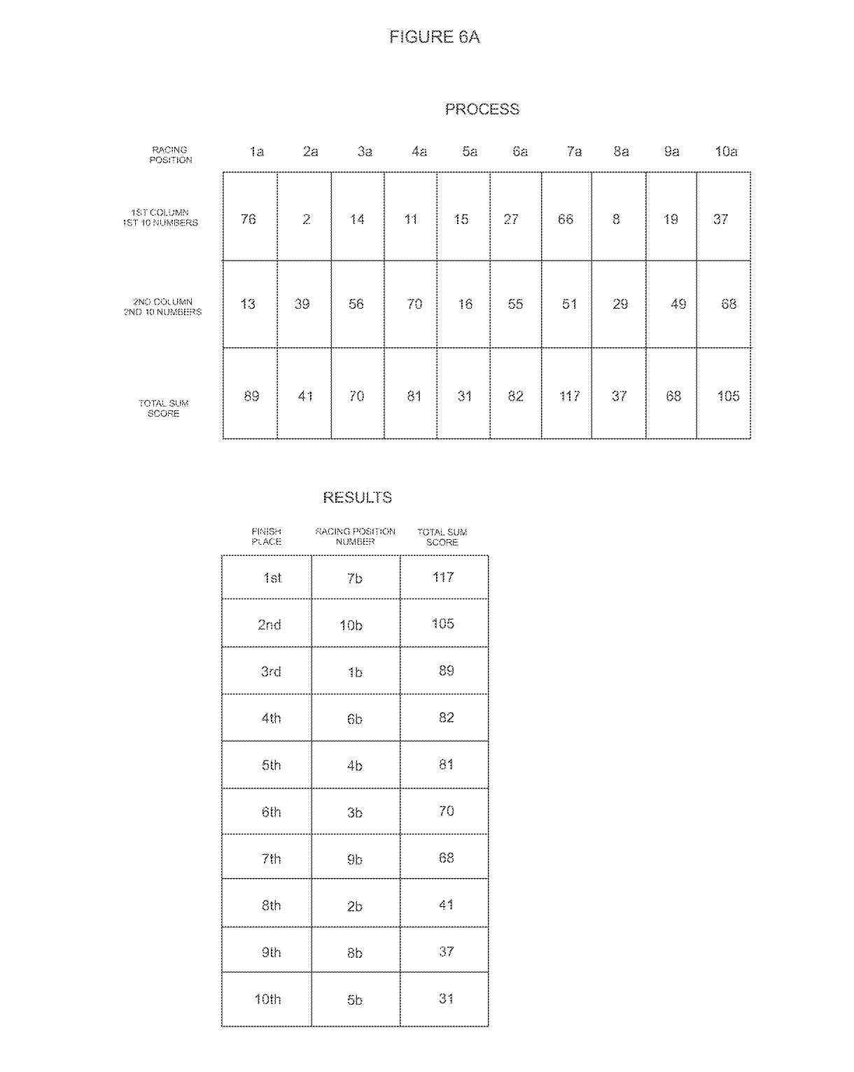

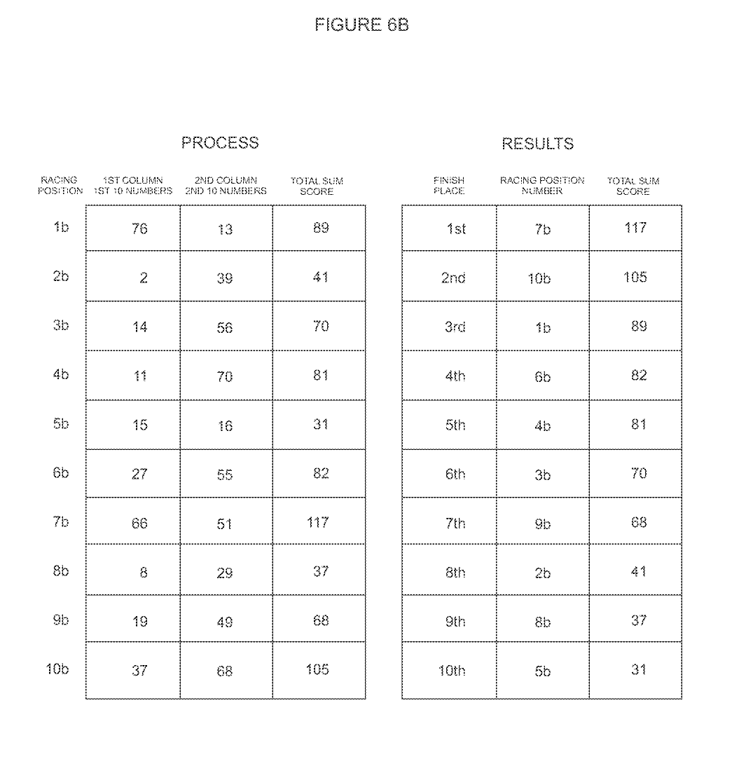

The grids (in this case, the two 10-position grids) are aligned with one ball in each array positioned parallel to or like-position aligned with a ball in the other array. Two useful variations of such alignments are shown in FIG. 6A.

The various positions on the deposit grid 6A are labeled 1a-10a on the horizontal grid array 6A and 1b-10b on the vertical grid array 6B. Racing positions are artificially constructed of parallel or adjacent racing positions of two frames in the separate grids, for example, la, 2b, 6a, 8b or 10b. The “score” of each racing position is the sum or total count of the two balls in the racing position. Looking at FIG. 6B, for example, the “scores” for various racing positions are 1b=(76+13=89); 2b=(2+39=41); 3b=(14+56=70); 4b=(11+70−81); 5b−(15+16=31); 6b=(27+55+82); 7b=(66+51=117); 8b=(8+29+37); 9b=(19+49=68); and 10b=(37+68=105). The racing positions are then ranked according to the highest total sum scores, such as from FIG. 6B of

| | |
|---|---|
| 7b | 117 |
| 10b | 105 |
| 1b | 89 |
| 6b | 82 |
| 4b | 81 |
| 3b | 70 |
| 9b | 68 |
| 2b | 41 |
| 8b | 37 |
| 5b | 31 |

If there were a tie in scores for any racing positions, the tie in ranking may be automatically broken by placing the racing positions in order of a highest individual ball in the racing positions. Therefore, if there were three racing positions with a total score of 60 with balls of individual ranks (A 56+4). (B 45+15) and (C 33+27), they would be ranked on the order of final racing positions as A, B and C because of the individual highest balls in each of A B and C.

The side bet or side bets are based on any of a number of combinations of sub-outcomes in the keno or bingo game. (In the Bingo variant, the balls are also ranked in order, although because of the underlying nature of the game, not all boxes in the arrays of race positions are necessarily filled. Although wagering structures and odds may address that issue, it is also possible, after completion of a Bingo game, for the remaining necessary boxes in the arrays to be artificially and rapidly filled by the processor randomly providing numbers to unfilled frames. If more than 20 balls happen to be selected in a Bingo game, only the first twenty balls selected will be used in the race and chase game.)

Race wagers may be placed in manners similar to horse betting wagers, with such wagering events as Win, Place, Show, Trifecta, Perfecta/Exacta, quinella wagers and the like. A completely novel wagering event can be placed by a player selecting an order for all ten racing positions in a single game event, referred to herein as the Chase game event. This event can be based on a number of game interpretative bases. For example, one outcome determinant will be how many selections match the specific position in an actual finish order. Another game determinant event will be how many consecutive positions starting with position 1 (the “winner”) are correctly chosen. Another game determinant event could be how many consecutive positions starting with position 10 (the “last place finisher”) are correctly chosen. Another game determinant event could be how many consecutive places were actually selected from any position in the field. In the last event, for example, if the wager were on race positions 1-10 in order, and the actual finish was 10, 1, 3, 4, 5, 6, 9, 2, 8, 7, there were four consecutive correct position finishers. In a related event, if the wager was again made on positions 1-10 in order and the final order of finish was 7, 3, 4, 5, 6, 9, 2, 1, 8, 10, there were four numbers in consecutive order (again 3, 4, 5 and 6) and although those numbers appeared in finish positions 2 (for 3), 3 (for 4), 4 (for 5) and 5 (for 6), there were four consecutive positions from the original wager in the final game event positions. This outcome might be a wagering event as a side bet or an automatic payout at less odds than the previous payout odds for the event where the four consecutive race positions were in the numerically correct positions (e.g., 4 was picked for 4^{th} place, 5 was picked for 5^{th} place, etc.).

Variations and options and alternative play within the scope of this generic invention could be practiced by those skilled in the art and be within the scope of the claims in this patent document.

The system may further operate by the wager first being established by first inserting currency or a printed voucher ticket into a scanner on the gaming system, the scanner reading specific value from the currency or printed voucher ticket and accounting for the read specific value as wagerable credit in the gaming system, storing the wagerable credit in the processor and then recognizing the wager of credit as credit removed from the stored wagerable credit. Then, while there is wagerable credit stored in the processor (e.g., after accumulating wins and losses in game execution), a player input control is actuated to cause a printer in the gaming system to print out a printed voucher ticket identifying enabling subsequent use of the printed ticket for all remaining stored wagerable credit, and removing all of the stored wagerable credit from the processor.

1. A process of executing a wagering event, the wagering event being executed on a gaming system comprising a processor, memory, a random number generator, player input controls, value-in-value-out system that establishes wagering credit in the processor and a video display system, wherein:
the processor recognizing a wager of credit input to the processor through the value-in-value-out system at a player input position on a first wagering game;
the processor providing two regions for display of two distinct distributional arrays, a first distributional array of at least 40 selectable alphanumerics in columns and rows, and a second distributional array of frames forming four distinct pairs of linear arrays of frames for collecting at least twenty random alphanumeric selections, each pair of the linear arrays aligned with a column or row of the first distributional array;
the processor recognizing positions of all specific alphanumerics in the first distributional array,
the random number generator effecting random distribution of sufficient ones of the random selectable alphanumerics within the second distributional array, thereby filling all frames forming the four distinct pairs of linear arrays of frames;
the processor determining correspondence of specific alphanumerics in the first distributional array with the ones of the random selectable alphanumerics in each pair of linear arrays with respect to the aligned columns and rows; and
the processor determining an award payable through the value-in-value-out system as a winning credit, a push or a loss of credit on the recognized wager against a paytable dependent on the determined correspondence of specific alphanumerics in the first distributional array with the ones of the random selectable alphanumerics in each pair of linear arrays with respect to the aligned columns and rows.

2. The method of claim 1 wherein the processor provides the first distributional array as an array of at least 80 selectable alphanumerics in ten columns and eight rows and provides the second distributional array as an array of 80 frames forming four distinct pairs of linear arrays of 10 frames in each linear array for collecting at least twenty random alphanumeric selections in each pair of linear arrays, each pair of the linear arrays aligned with a column or row of the first distributional array.

3. The method of claim 2 wherein the processor uses an entire set of eighty selectable alphanumerics used to fill all frames in the four distinct pairs of linear arrays of 10 frames in each linear array for collecting at least twenty random alphanumeric selections in each pair of linear arrays.

4. The method of claim 2 wherein the processor uses distinct and separate sets of eighty selectable alphanumerics to fill all frames in each of the four distinct pairs of linear arrays of 10 frames in each linear array for collecting at least twenty random alphanumeric selections in each pair of linear arrays.

5. The method of claim 2 wherein the alphanumerics comprise a set of numbers from 1 to 80 inclusive.

6. The method of claim 3 wherein the alphanumerics comprise a set of numbers from 1 to 80 inclusive.

7. The method of claim 4 wherein the alphanumerics comprise a set of numbers from 1 to 80 inclusive.

8. The method of claim 1 wherein the wager is established by first inserting currency or a printed voucher ticket into a scanner on the gaming system, the scanner reading specific value from the currency or printed voucher ticket and accounting for the read specific value as wagerable credit in the gaming system, storing the wagerable credit in the processor and then recognizing the wager of credit as credit removed from the stored wagerable credit.

9. The method of claim 2 wherein the wager is established by first inserting currency or a printed voucher ticket into a scanner on the gaming system, the scanner reading specific value from the currency or printed voucher ticket and accounting for the read specific value as wagerable credit in the gaming system, storing the wagerable credit in the processor and then recognizing the wager of credit as credit removed from the stored wagerable credit.

10. The method of claim 3 wherein the wager is established by first inserting currency or a printed voucher ticket into a scanner on the gaming system, the scanner reading specific value from the currency or printed voucher ticket and accounting for the read specific value as wagerable credit in the gaming system, storing the wagerable credit in the processor and then recognizing the wager of credit as credit removed from the stored wagerable credit.

11. The method of claim 4 wherein the wager is established by first inserting currency or a printed voucher ticket into a scanner on the gaming system, the scanner reading specific value from the currency or printed voucher ticket and accounting for the read specific value as wagerable credit in the gaming system, storing the wagerable credit in the processor and then recognizing the wager of credit as credit removed from the stored wagerable credit.

12. The method of claim 5 wherein the wager is established by first inserting currency or a printed voucher ticket into a scanner on the gaming system, the scanner reading specific value from the currency or printed voucher ticket and accounting for the read specific value as wagerable credit in the gaming system, storing the wagerable credit in the processor and then recognizing the wager of credit as credit removed from the stored wagerable credit.

13. The method of claim 6 wherein the wager is established by first inserting currency or a printed voucher ticket into a scanner on the gaming system, the scanner reading specific value from the currency or printed voucher ticket and accounting for the read specific value as wagerable credit in the gaming system, storing the wagerable credit in the processor and then recognizing the wager of credit as credit removed from the stored wagerable credit.

14. The method of claim 7 wherein the wager is established by first inserting currency or a printed voucher ticket into a scanner on the gaming system, the scanner reading specific value from the currency or printed voucher ticket and accounting for the read specific value as wagerable credit in the gaming system, storing the wagerable credit in the processor and then recognizing the wager of credit as credit removed from the stored wagerable credit.

15. The method of claim 8 wherein, while there is wagerable credit stored in the processor, a player input control is actuated to cause a printer in the gaming system to print out a printed voucher ticket identifying enabling subsequent use of the printed ticket for all remaining stored wagerable credit, and removing all of the stored wagerable credit from the processor.

16. The method of claim 9 wherein, while there is wagerable credit stored in the processor, a player input control is actuated to cause a printer in the gaming system to print out a printed voucher ticket identifying enabling subsequent use of the printed ticket for all remaining stored wagerable credit, and removing all of the stored wagerable credit from the processor.

17. The method of claim 10 wherein, while there is wagerable credit stored in the processor, a player input control is actuated to cause a printer in the gaming system to print out a printed voucher ticket identifying enabling subsequent use of the printed ticket for all remaining stored wagerable credit, and removing all of the stored wagerable credit from the processor.

18. The method of claim 11 wherein, while there is wagerable credit stored in the processor, a player input control is actuated to cause a printer in the gaming system to print out a printed voucher ticket identifying enabling subsequent use of the printed ticket for all remaining stored wagerable credit, and removing all of the stored wagerable credit from the processor.

19. The method of claim 12 wherein, while there is wagerable credit stored in the processor, a player input control is actuated to cause a printer in the gaming system to print out a printed voucher ticket identifying enabling subsequent use of the printed ticket for all remaining stored wagerable credit, and removing all of the stored wagerable credit from the processor.

20. The method of claim 13 wherein, while there is wagerable credit stored in the processor, a player input control is actuated to cause a printer in the gaming system to print out a printed voucher ticket identifying enabling subsequent use of the printed ticket for all remaining stored wagerable credit, and removing all of the stored wagerable credit from the processor.
